(19) United States
(12) Patent Application Publication
(10) Pub. No.: US 2016/0380899 A1
(43) Pub. Date: Dec. 29, 2016

(54) METHOD AND APPARATUS FOR DYNAMIC TRAFFIC CONTROL IN SDN ENVIRONMENT

(71) Applicant: KT CORPORATION, Seongnam-si (KR)

(72) Inventors: Se Hui LEE, Daejeon (KR); Tae Jin AHN, Daejeon (KR); Kyung Ah HAN, Daejeon (KR)

(73) Assignee: KT Corporation, Seongnam-si (KR)

(21) Appl. No.: 15/039,470

(22) PCT Filed: Nov. 28, 2014
(86) PCT No.: PCT/KR2014/011584

§ 371 Date: May 26, 2016

(30) Foreign Application Priority Data
Nov. 28, 2013 (KR) 10-2013-0146618
Nov. 28, 2014 (KR) 10-2014-0168737

(51) Int. Cl. H04L 12/813; H04L 12/24; H04L 12/26; H04L 12/715

(52) U.S. Cl. CPC H04L 47/20; H04L 45/64; H04L 41/0896; H04L 43/16; H04L 67/02

(57) ABSTRACT

Disclosed are a method and an apparatus for dynamic traffic control in real-time through a linkage of a controller and a network device. The method for dynamic traffic control comprises the steps of: creating at least one flow entry for controlling the traffic of the network device; and controlling the traffic of the network device by transferring the created at least one flow entry to the network device, wherein the at least one flow entry contains information of a threshold value or a target value for the traffic for controlling the traffic. Accordingly, a communication load between the network device and the controller and a system load of the network device can be reduced. Further, it is possible to provide real-time service through a dynamic traffic control.

### TECHNICAL FIELD

The present disclosure relates to a software defined networking technology, and more particularly to a method and an apparatus for dynamically controlling traffics in real time through interoperations between a controller and a network apparatus.

### BACKGROUND ART

Software-defined networking (SDN) means a user-oriented network in which a user has control authority regardless of a basic network device such as a router or a switch, etc. and a separate software controller controls a flow of traffic.

In the SDN environment, a flow table including identification information of traffic flows and information for processing flows is managed. When actual user traffic is generated, a flow entry corresponding to the generated traffic is identified using the flow table, and a packet processing manner for the generated traffic is determined according to the identified flow entry.

The packet processing manners in the SDN environment may include traffic forwarding, traffic dropping, traffic modification, traffic queuing, etc.

The traffic forwarding is a function of outputting traffics through a specific output port, and the traffic dropping is a function of discarding traffics without outputting them through a specific output port. Also, the traffic modification is a function of modifying information of traffic headers such as virtual local area network (VLAN) tags, and the traffic queuing is a function of providing a Quality of Service (QoS) by scheduling traffics by using a queue in the traffic forwarding.

On the other hand, in the SDN environment, the network apparatus may control network traffics by using flow tables transferred from the controller. If the flow tables are not changed by the controller, only a single traffic control policy can exist for each flow.

However, in such the environment, there is a problem that traffics cannot be dynamically controlled according to real-time traffic state information such as usage duration of flows, the number of packets used for each flow, and the amount of packets used for each flow.

### DISCLOSURE

### Technical Problem

The purpose of the present invention for resolving the above-described problem is to provide a method for dynamically controlling traffics in the SND environment in real time.

### Technical Solution

In order to achieve the above-described purpose of the present invention, a method for controlling traffic in a software defined networking (SDN) environment, performed by a controller, according to an aspect of the present invention, may comprise creating at least one flow entry for controlling a traffic of a network apparatus; and controlling the traffic of the network apparatus by transferring the created at least one flow entry to the network apparatus, wherein the at least one flow entry contains information of a threshold value or a target value for the traffic for controlling the traffic.

Here, the threshold value or the target value for the traffic may include at least one of target counter information of the traffic, target service class information of the traffic, and quota information of the traffic.

Here, the controlling the traffic of the network apparatus may comprise updating a flow table of the network apparatus by transferring the at least one flow entry to the network apparatus; and applying, to the network apparatus, a traffic control policy corresponding to the at least one flow entry included in the updated flow table.

Here, in the controlling the traffic of the network apparatus, the traffic of the network apparatus may be controlled by transferring, to the network apparatus, the at least one flow entry configured based on target counter information of the traffic.

Also, the target counter information of the traffic may be compared with counter information of the traffic which is increased by the network apparatus based on a number of transmitted packets belonging to the traffic.

Also, in the controlling the traffic of the network apparatus, a first flow entry may be applied when the counter information of the traffic does not exceed than the target counter information of the traffic, and a second flow entry may be applied when the counter information of the traffic exceeds the target counter information of the traffic.

Here, in the controlling the traffic of the network apparatus, the first flow entry may be deleted from the network apparatus after applying the first flow entry.

Also, in the controlling the traffic of the network apparatus, an advertisement service may be provided through the traffic when the counter information of the traffic is a predetermined value.

Also, the predetermined value may indicate a first traffic of the traffic.

Here, the controlling the traffic of the network apparatus may comprise transferring, to the network apparatus, the at least one flow entry including target service class information of the traffic, the target service class information being configured based quota information of the traffic; and controlling the traffic from the network apparatus according to the target service class information of the traffic.

Also, in the controlling the traffic of the network apparatus, the traffic may be controlled to be forwarded to a premium service when a usage amount of the traffic does not exceed the quota information of the traffic.

Also, in the controlling the traffic of the network apparatus, a first flow entry for provisioning of the premium service may be applied when the usage amount of the traffic does not exceed than the quota information, and a second flow entry for provisioning of a basic service may be applied when the usage amount of the traffic exceeds the quota information.

Also, in the controlling the traffic of the network apparatus, the first flow entry may be deleted from the network apparatus after applying the first flow entry.

In order to achieve the above-described purpose of the present invention, a method for controlling traffic in a software defined networking (SDN) environment, performed by a network apparatus, according to another aspect of the present invention, may comprise transferring traffic generated in a user terminal to a controller; and controlling the traffic generated in the user terminal by receiving at least one flow entry generated by the controller in response to the transferring, wherein the at least one flow entry contains information of a threshold value or a target value for the traffic for controlling the traffic.

### Advantageous Effects

The above-described dynamic traffic control methods according to the present invention may reduce communication loads between the network apparatus and the controller and system loads of the network apparatus, and provide real-time service through dynamic control on traffics.

Also, the methods, as traffic path control and QoS control techniques, may be applied to new services such as user interest based advertisements, user network access authentication services, network-based internet supplementary services, etc. of telecommunication operators.

### DESCRIPTION OF DRAWINGS

FIG. 1 is an exemplary view to explain a system for performing dynamic traffic control according to an exemplary embodiment of the present invention.

FIG. 2 is a block diagram to explain a configuration of a controller and a network apparatus which perform dynamic controls according to an exemplary embodiment of the present invention.

FIG. 3 is an exemplary view to explain a data structure of a flow table according to an exemplary embodiment of the present invention.

FIG. 4 is a sequence chart to explain a method for updating a flow table of a network apparatus according to an exemplary embodiment of the present invention.

FIG. 5 is a flow chart to explain a method for controlling traffics by a network apparatus according to an exemplary embodiment of the present invention.

FIG. 6 is a flow chart to explain a method for controlling traffics by using counter information of traffics according to an exemplary embodiment of the present invention.

FIG. 7 is a sequence chart to explain a method for controlling traffics to provide advertisement services according to an exemplary embodiment of the present invention.

FIG. 8 is a sequence chart to explain a method for controlling traffics based on traffic usage amount according to an exemplary embodiment of the present invention.

### BEST MODE

While the invention is susceptible to various modifications and alternative forms, specific embodiments thereof are shown by way of examples in the drawings and will herein be described in detail. It should be understood, however, that there is no intent to limit the invention to the particular forms disclosed, but on the contrary, the invention is meant to cover all modifications, equivalents, and alternatives falling within the spirit and scope of the invention. Like numbers refer to like elements in the accompanying drawings.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a ‘controller’ in the specification means a functional entity controlling related components (for example, switches, routers, etc.) in order to control flows of traffic.

Also, the controller is not restricted to a specific physical implementation or a specific implementation position. For example, the controller may mean a controller functional entity defined in ONF, IETF, ETSI, or ITU-T.

A ‘network apparatus’ in the specification means a functional entity performing traffic (or, packet) forwarding, switching, or routing. Accordingly, in the specification, the network apparatus may also be referred to as a ‘switch’ or ‘router’.

For example, the network apparatus may mean a switch, a router, a switching element, a routing element, a forwarding element, etc. defined in ONF, IETF, ETSI, or ITU-T.

Various parameters and/or messages, defined for explanation on methods for dynamically controlling traffics in the SDN environment, are not limited to specific parameter and/or messages in the exemplary embodiments of the present invention.

Hereinafter, preferred exemplary embodiments according to the present invention will be explained in detail by referring to accompanying figures.

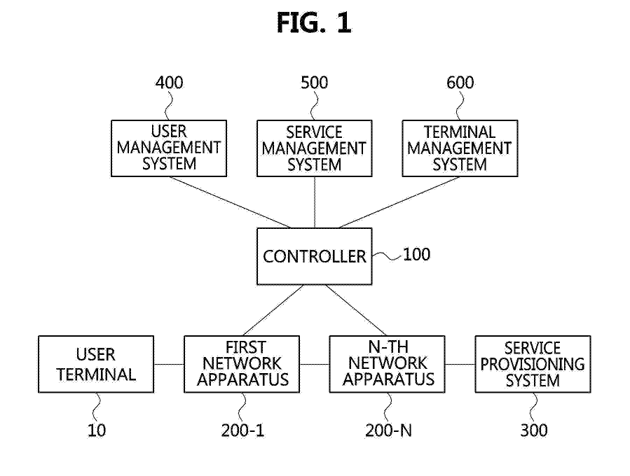

FIG. 1 is an exemplary view to explain a system for performing dynamic traffic control according to an exemplary embodiment of the present invention.

Referring to FIG. 1, a user may use a plurality of services through a plurality of user terminals 10 or a single user terminal 10.

The user terminal may be connected to a service provisioning system 300 through a plurality of network apparatuses 200-1 to 200-n.

The service provisioning system 300 may comprise a plurality of systems, and each of the service provisioning system 300 may provide one or more internet services.

The service provisioning system 300 may be constructed by a service provider or an internet service provider.

A network may comprise the plurality of network apparatuses 200-1 to 200-n, and a controller 100 may control and manage the plurality of network apparatuses 200-1 to 200-n.

The network apparatus 200 may be a switch or a router corresponding to a data plane of a SDN network, or may be a policy based router (PBR) corresponding to a policy enforcement point (PEP) of a policy based network. For example, in the case of the SDN network, the network apparatus 200 may be an OpenFlow switch according to an Open Networking Foundation (ONF) standardization organization, or may be a Network Element (NE) or an I2RS agent in the I2RS protocol of the IETF.

The controller 100 may be a controller system corresponding to a control plane of the SDN network, or may be a policy control system corresponding to a policy decision point (PEP) of a policy based network. For example, in the case of the SDN network, the controller 100 may be an OpenFlow controller according to the ONF standardization organization, or may be a topology manager or an I2RS client in the I2RS protocol of the IETF.

The controller 100 may be formed as multiple entities in a form of master-master or master-slave. Also, a single network apparatus may be controller and managed by a plurality of controllers. Furthermore, a single controller may be connected to a plurality of application systems. The application system may include a user management system 400, a service management system 500, a terminal management system 600, etc.

The user management system 400 may configure user identification information, names of services being used, and maximum permissible traffic amount (quota). Also, the controller 100 may monitor a traffic amount which was actually used by a user, and may dynamically control traffic of the user when the actually-used traffic amount reaches the quota.

The service management system 500 may configure names of services, and maximum usable traffic amounts for respective services. Also, the controller 100 may monitor a traffic amount for each service, and may dynamically control the corresponding service traffic when the traffic amount of each service reaches the maximum usable traffic amount. For example, services provided through the user terminal 10 may include a smart TV service, a peer to peer (P2P) service, a video-on-demand (VoD) service, a web hard service, etc.

The terminal management system 600 may configure a terminal type, a maximum usable traffic amount for each terminal, etc. The controller 100 may a traffic amount for each terminal, and may dynamically control a traffic of each terminal when the traffic amount of each terminal reaches the maximum usable traffic amount. For example, the user terminal may include a usual personal computer, a smart TV, a smart phone, a smart pad, a game console, a set top box, etc.

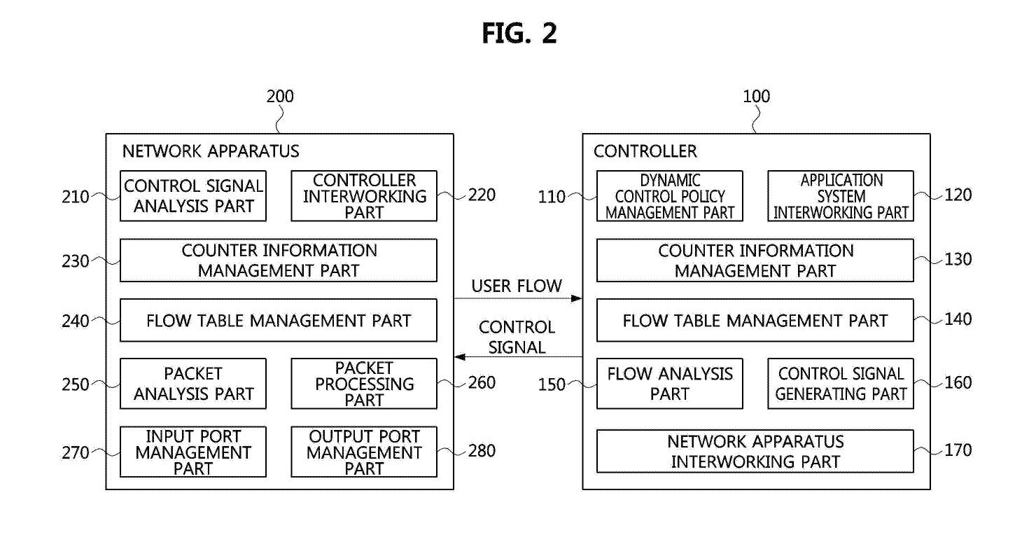

FIG. 2 is a block diagram to explain a configuration of a controller and a network apparatus which perform dynamic controls according to an exemplary embodiment of the present invention.

Referring to FIG. 2, a network apparatus 200 may transfer user flows to a controller 100, and the controller 100 may transfer control signals to the network apparatus so that they can interoperate with each other.

The network apparatus 200 may comprise a control signal analysis part 210, a controller interworking part 220, a counter information management part 230, a flow table management part 240, a packet analysis part 250, a packet processing part 260, an input port management part 270, and an output port management part 280.

The control signal analysis part 210 may analyze control signals received from the controller 100 through the controller interworking part 22.

The counter information management part 230 may manage counter information of traffic. For example, the counter information management part 230 may compare counter information included in a flow entry received from the controller 100 with a predetermined value.

The flow table management part 240 may management flow tables of the network apparatus 200.

The packet analysis part 250 may analyze packets received from the user terminal 10, and the packet processing part 260 may process the packets based on information on the analyzed packets.

The input port management part 270 may manage input ports of the network apparatus 200, and the output port management part 280 may manage output ports of the network apparatus 200.

The controller 100 may comprise a dynamic control policy management part 110, an application system interworking part 120, a counter information management part 130, a flow table management part 140, a flow analysis part 150, a control signal generating part 160, and a network apparatus interworking part 170.

The dynamic control policy management part 110 may store and manage traffic control policies for dynamically controlling traffics.

The application system interworking part 120 may control protocols in order to interoperate with the application systems such as the user management system 400, the service management system 500, and the terminal management system 600.

The counter information management part 130 may manage counter information of traffics. For example, the counter information management part 130 may manage counter information based on the numbers of transmitted packets for respective traffics, and store the counter information.

The flow table management part 140 may store and manage a plurality of flow tables of a network stored in the controller 100.

The flow analysis part 150 may analyze flows received from the network apparatus 200, and the control signal generating part 160 may generate control signals based on the analysis result on the flows.

The network apparatus interworking part 170 may control protocols in order to communicate with the network apparatus.

The controller 100, according to an exemplary embodiment of the present invention, may mange a real-time dynamic control policy in order to dynamically control user traffics in real-time, and configure the dynamic control policy by utilizing user profile information, service profile information, and terminal profile information which were provided by the application systems. Here, the dynamic control policy may also be referred to as a traffic control policy.

More specifically, the controller 100 may perform determination of packet processing manner, determination of traffic paths, and determination of QoS operations, and provide a network control policy to the network apparatus 200. The network apparatus 200 may actually control network traffics according to the network control policy provided by the controller 100.

The controller 100 and the network apparatus 200 may manage the network control policy by exchanging flow tables. Here, the flow table may include identification information of traffic flows, information on flow processing manners, counter information, etc.

When traffic occurs, the controller 100 may identify a flow entry corresponding to the traffic in a flow table, and determine a packet processing manner for the traffic according to the identified flow entry. Also, the controller 100 may update counter information of the corresponding flow entry.

Meanwhile, there are traffic forwarding, traffic dropping, traffic modification, traffic queuing, etc. as the packet processing manners. The traffic forwarding may mean a function of forwarding the traffic to an output port, and the traffic dropping may mean a function of discarding the traffic without outputting an output port. Also, the traffic modification may mean a function of modifying information such as traffic headers (e.g. VLAN tags), and the traffic queuing may mean a function of providing QoS control features by utilizing queues and scheduling the traffic during the traffic forwarding procedure.

The counter information may include the number and usage amount of packets, the number and usage amount of packets corresponding to the flow, the number and amount of packets in which traffic drop occurs, a time at which correspondence to the last flow is identified, etc. Therefore, the network apparatus 200 may mange updated counter information and transfer the counter information to the controller 100 periodically.

The controller 100 may request the network apparatus 200 to add, modify, or delete information of a flow table.

The network apparatus 200 cannot add or modify information of its flow table autonomously. The network apparatus 200 can delete information of its flow table restrictedly. For example, the network apparatus 200 may delete a flow entry in accordance with an expiration time of the flow entry, or delete a flow entry in a case that the flow entry has not been used for predetermined time duration. Also, the network apparatus 200 may delete excess flow entries according to the maximum manageable number of flow tables.

Accordingly, the present disclosure provides various methods for the network apparatus 200 to dynamically manage traffics by dynamically managing flow tables according to configuration given by the controller 100.

That is, according to exemplary embodiments of the present invention, traffics can be dynamically controlled based on real-time traffic state information such as the number of used packets, duration of use, specific times, etc. as well as the usage amount of traffic for a service flow.

For example, as a case in which a real-time dynamic control is performed by utilizing information on the number of used packets, a case of dynamically controlling a web (HTTP) traffic may be considered. Only the first HTTP traffic which a user uses through a web browser firstly can be forwarded to a specific web server not an original destination web server, and HTTP traffics after the first HTT traffic can be forwarded to the original destination web server in order to normally receive services provided by the original web server.

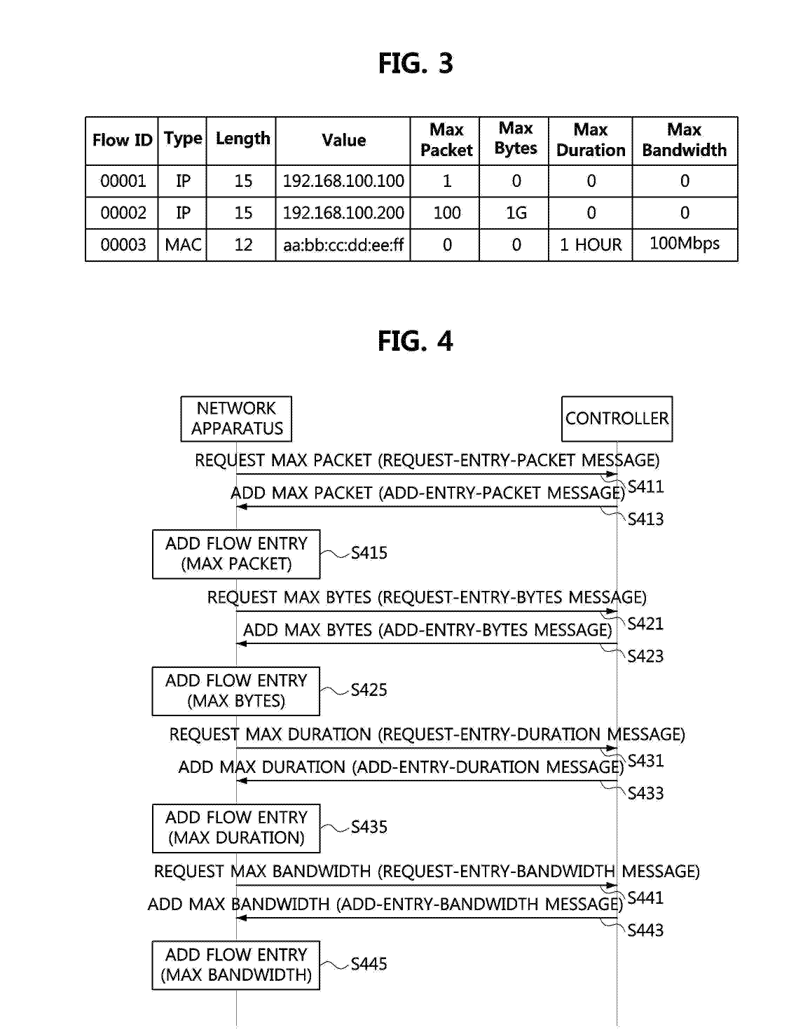

FIG. 3 is an exemplary view to explain a data structure of a flow table according to an exemplary embodiment of the present invention.

Referring to FIG. 3, a data structure of a flow table may comprise data fields such as a Flow ID, TYPE, Length, Value, Max Packet, Max Bytes, Max Duration, Max Bandwidth, etc., and comprise a plurality of flow entries.

The ‘Flow ID’ may be identification information for discriminating flow entries, the ‘TYPE’ may be information for indicating the type of a flow such as MAC or IP of a terminal, and the ‘Value’ may be identification information of a flow corresponding to the type of the flow.

Also, the ‘Max Packet’, ‘Max Bytes’, ‘Max Duration’, and ‘Max Bandwidth’ may mean threshold values used for deleting the corresponding flow entry.

More specifically, when the number of matched packets reaches the value of ‘Max Packet’, the corresponding flow entry may be deleted. Also, when the total byte amount of matched packets reaches the value of ‘Max Bytes’, the corresponding flow entry may be deleted. Also, when duration of using the flow reaches the value of ‘Max Duration’, the corresponding flow entry may be deleted. Also, when the bandwidth of the flow reaches the value of ‘Max Bandwidth’, the corresponding flow entry may be deleted.

FIG. 4 is a sequence chart to explain a method for updating a flow table of a network apparatus according to an exemplary embodiment of the present invention.

Referring to FIG. 4, the network apparatus may request flow entry information to the controller by using a Request-Entry-Packet/Bytes/Duration/Bandwidth message, and each message may include information on the value of ‘Max Packet’, ‘Max Bytes’, ‘Max Duration’, or ‘Max Bandwidth’.

The controller may analyze the received message, and transfer the requested flow entry information to the network apparatus by using an Add-Entry-Packet/Bytes/Duration/Bandwidth message, and each message may be transmitted to the network apparatus as including the value of ‘Max Packet’, ‘Max Bytes’, ‘Max Duration’, or ‘Max Bandwidth’.

Therefore, the network apparatus may add or modify a flow entry in a flow table.

For example, the network apparatus may request the value of ‘Max Packet’ to the controller by using the Request-Entry-Packet message (S411), and the controller may request the network apparatus to add the value of ‘Max Packet’ by using the Add-Entry-Packet message (S413). Therefore, the network apparatus may add a flow entry according to the request of adding ‘Max Packet’ (S415).

The network apparatus may request the value of ‘Max Bytes’ to the controller by using the Request-Entry-Bytes message (S421), and the controller may request the network apparatus to add the value of ‘Max Bytes’ by using the Add-Entry-Bytes message (S423). Therefore, the network apparatus may add a flow entry according to the request of adding ‘Max Bytes’ (S425).

The network apparatus may request the value of ‘Max Duration’ to the controller by using the Request-Entry-Duration message (S431), and the controller may request the network apparatus to add the value of ‘Max Duration’ by using the Add-Entry-Duration message (S433). Therefore, the network apparatus may add a flow entry according to the request of adding ‘Max Duration’ (S435).

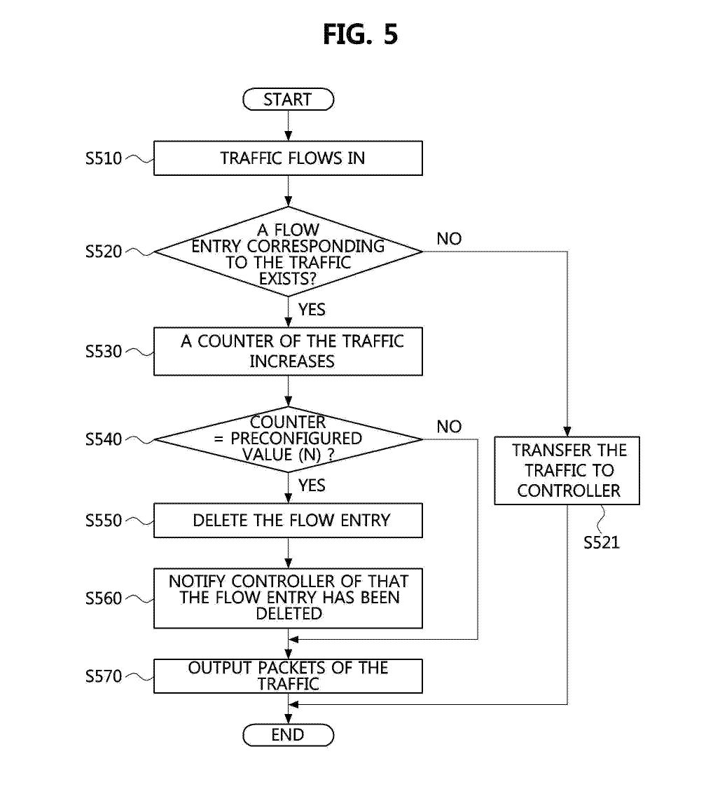

FIG. 5 is a flow chart to explain a method for controlling traffics by a network apparatus according to an exemplary embodiment of the present invention.

Referring to FIG. 5, a traffic flows in the network apparatus (S510), and the network apparatus may identify whether a flow entry corresponding to the traffic exists or not in a flow table of the network apparatus (S520).

In a case that a flow entry corresponding to the traffic exists, a counter corresponding to the traffic may increase by 1 (S530). For example, if a previous counter value is n, the counter may increase to n+1. Also, the network apparatus may store and manage the updated counter information in the flow table. On the contrary, in a case that a flow entry corresponding to the traffic does not exist, the traffic may be transferred to the controller (S521).

The network apparatus may compare the updated counter information with a counter threshold value (N) configured for deletion of a flow entry (S540). If they coincide with each other, the network apparatus may deleted the corresponding flow entry (S550), notify the controller of that the flow entry has been deleted (S560), and output packets belonging to the traffic from the network apparatus (S570). Here, the counter threshold value (N) is a value which the controller configures by using a flow entry, and may be referred to as ‘target counter information’ of the traffic. Therefore, the target counter information of the traffic may be compared with counter information of the traffic, which is increased based on the number of transmitted packets according to the traffic.

Also, after the comparison, if the increased counter information does not coincide with the counter threshold value (N), the network apparatus may directly output the packets of the traffic (S570). That is, when the increased counter information does not coincide with the preconfigured counter threshold value (N), the corresponding flow entry is not deleted, and will be used for controlling following traffics.

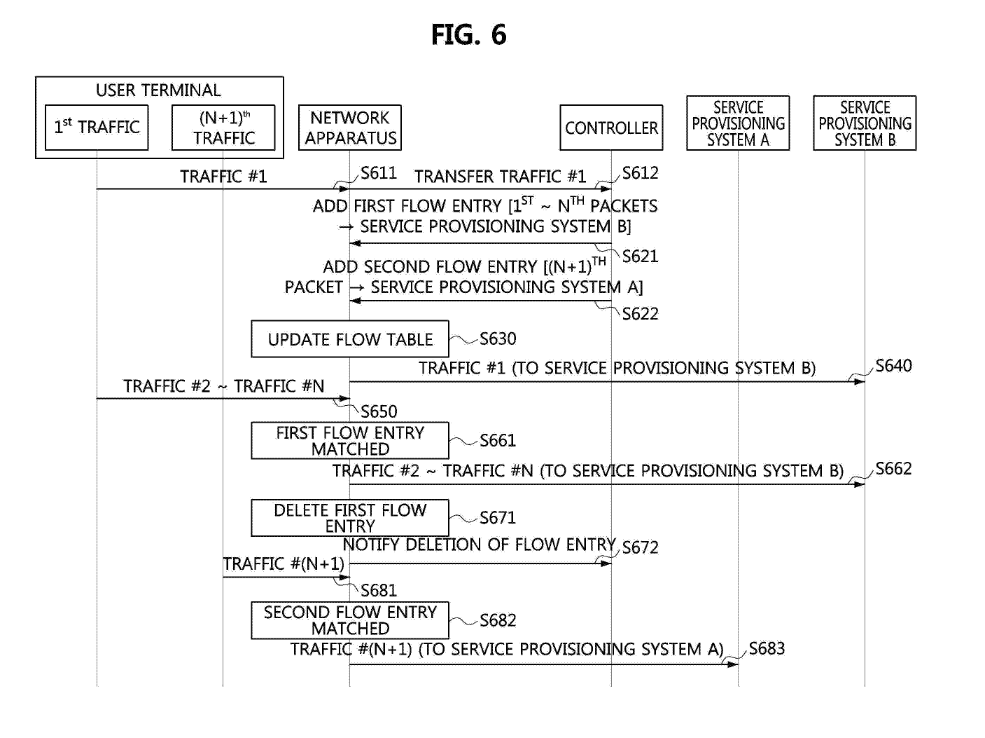

FIG. 6 is a flow chart to explain a method for controlling traffics by using counter information of traffics according to an exemplary embodiment of the present invention.

Referring to FIG. 6, a first traffic from a user terminal may flow into the network apparatus (S611). The first traffic is a traffic belonging to a service flow A. In the present exemplary embodiment, it is assumed that the first to (N+1)^{th} traffics also belong to the same service flow A.

The network apparatus may receive the first traffic (S611), identify whether a flow entry corresponding to the first traffic exists or not in a flow table of the network apparatus. When a flow entry corresponding to the first traffic does not exist in a flow table of the network apparatus, the network apparatus may request the controller to provide a flow entry corresponding to the first traffic by transferring the first traffic to the controller (S612). However, if a flow entry corresponding to the first traffic exists in the flow table of the network apparatus, a traffic control policy according to the flow entry may be applied.

The controller may generate a flow entry based on a traffic control policy corresponding to the first traffic, and request the network apparatus to add the generated flow entry (S621, S622).

For example, according to the traffic control policy, a first flow entry and a second flow entry may be added for the service flow A.

The first flow entry may be used to forward the first to the N^{th} traffics to a service provisioning system B, and the second flow entry may be used to forward the (N+1)^{th} and later traffics to a service provisioning system A. Here, the value N may mean target counter information of the traffic.

The controller may request the network apparatus to add the first flow entry (S621). Also, the controller may request the network apparatus to add the second flow entry (S622).

Thus, the flow table of the network apparatus may be configured as updated by using the first flow entry and the second flow entry (S630).

The first traffic, which is temporarily stored in the network apparatus, may be matched with the first flow entry and forwarded to the service provisioning system B (S640). At the same time, the counter information may increase by 1, and the first flow entry may be updated thereby.

Then, the second to N^{th} traffics of the service flow A may enter into the network apparatus consistently (S650).

The network apparatus may receive the second to the N^{th} traffics (S650), identify whether a flow entry corresponding to the received traffics exists or not in a flow table of the network apparatus, and identify that the second to N^{th} traffics are matched to the first flow entry (S661).

Accordingly, the second to the N^{th} traffics may be forwarded to the service provisioning system B (S662). Also, the first to N^{th} traffics have been forwarded so that the counter information for the first flow entry may be updated to N.

Since the network apparatus is configured to delete the first flow entry when the counter information of the first flow entry reaches N, the first flow entry may be deleted from the flow table (S671). Also, it may be notified to the controller that the first flow entry has been deleted (S672).

Then, the (N+1)^{th} and later traffics may enter into the network apparatus (S681).

The network apparatus may receive the (N+1)^{th} traffic (S681), identify whether a flow entry corresponding to the received traffic exists or not in the flow table, and identify that the (N+1)^{th} traffic is matched to the second flow entry (S682). Accordingly, the network apparatus may forward the (N+1)^{th} traffic to the service provisioning system A (S683).

Accordingly, the controller may control the network apparatus to use the first flow entry, when the counter information for the traffics of the service flow A is not greater than the target counter information of the service flow A, and control the network apparatus to use the second flow entry, when the counter information for the traffics of the service flow A is greater than the target counter information of the service flow A.

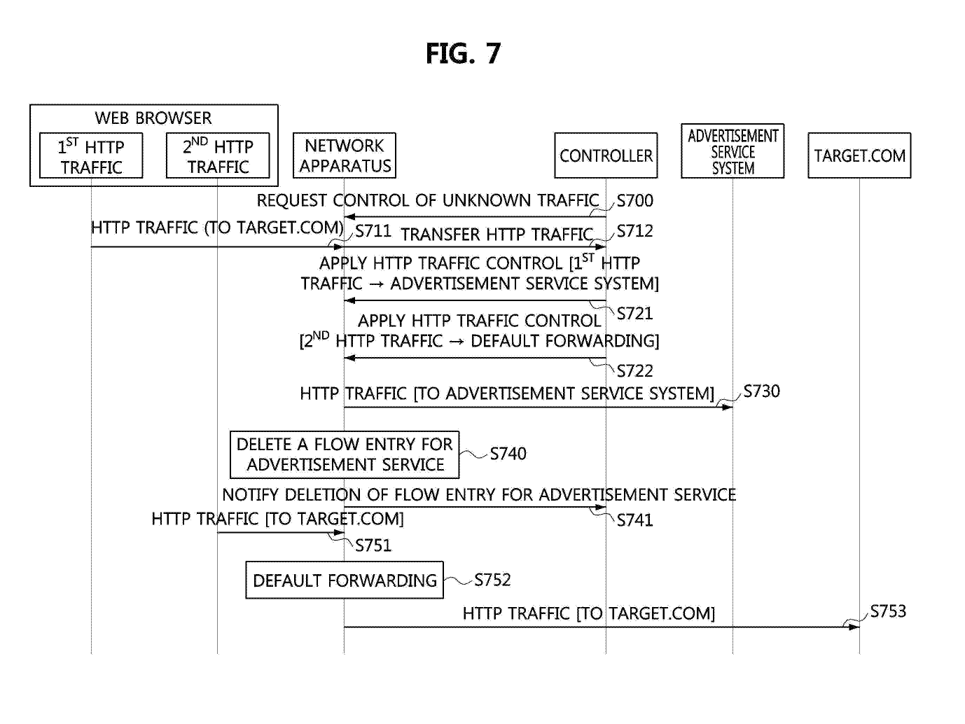

FIG. 7 is a sequence chart to explain a method for controlling traffics to provide advertisement services according to an exemplary embodiment of the present invention.

Referring to FIG. 7, in order to provide an advertisement service through a web browser of a specific user terminal, the controller may request the network apparatus to forward unknown traffics to the controller when they flow in (S700). Here, the unknown traffics may be HTTP traffics.

The HTTP traffic designating a specific web server (e.g. target.com) as a destination, which occurs in a web browser of a user terminal, may be inputted to the network apparatus (S711).

According to an exemplary embodiment of the present invention, instead of a web page of the specific web server (e.g. target.com), a web page corresponding to a user advertisement service may be provided to the web browser of the user terminal.

Specifically, since the network apparatus is configured to transfer unknown traffics to the controller, the HTTP traffic (i.e. the first HTTP traffic) may be transferred to the controller (S712).

The controller may identify a flow entry for controlling the HTTP traffic, and request the network apparatus to add the identified flow entry (S721, S722).

For example, only the first HTTP traffic may be controlled to be transferred to the advertisement service system, and the later HTTP traffics may be controlled to be transferred to the corresponding web server (i.e. target.com).

In order to provide the advertisement service web page by forwarding the HTTP traffic to the advertisement service system instead of the original destination, technologies such as IP tunneling techniques, etc. may be used between the network apparatus and the advertisement service system.

The controller may transfer a first flow entry, which forwards the first HTTP traffic to the advertisement service system, to the network apparatus (S721).

Also, the controller may transfer a second flow entry, which normally forwards the second and later HTTP traffics to the specific destination web server (i.e. target.com), to the network apparatus (S722).

Therefore, the network apparatus may configure the flow table to have the above two flow entries.

The network apparatus may identify that the temporarily stored first HTTP traffic is matched to the first flow entry, forward the first HTTP traffic to the advertisement service system (S730). Through this, the web browser of the user terminal may present the web service web page. At the same time, the network apparatus may update the first flow entry by increasing counter information by 1.

That is, the controller may control the network apparatus to provide the advertisement service through a traffic when counter information for the traffic is a predetermined value, and the predetermined value may be configured to indicate the first HTTP traffic.

Since the first flow entry is configured to be deleted when the corresponding counter information reaches 1, the network apparatus may delete the first flow entry from the flow table (S740), and notify the controller that the first flow entry has been deleted (S741).

Then, the later HTTP traffics may be inputted to the network apparatus (S751). The network apparatus may identify that the HTTP traffics are matched to the second flow entry, and forward the HTTP traffics to the web server (target.com) which is the original destination (S7530). Through this, the web browser of the user terminal can receive HTTP web pages of the original destination web server.

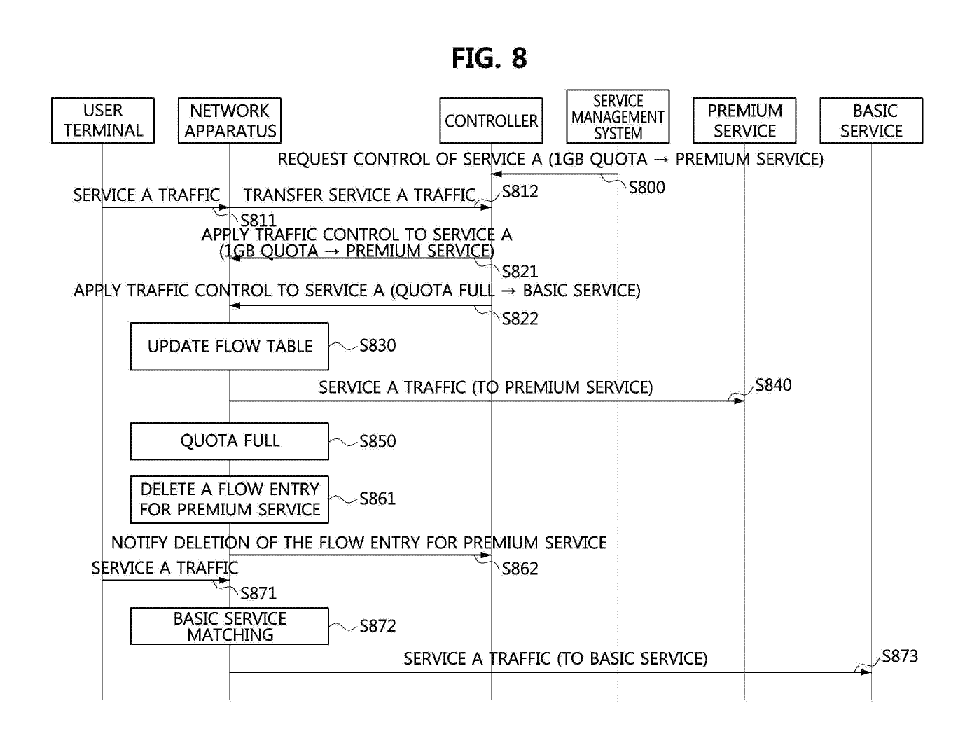

FIG. 8 is a sequence chart to explain a method for controlling traffics based on traffic usage amount according to an exemplary embodiment of the present invention.

Referring to FIG. 8, an exemplary embodiment of the present invention may provide a method for providing a premium service through dynamic traffic control based on traffic usage amount of a user.

In FIG. 8, a service A may be provided as a basic service or a premium service. For example, in case of a video service, the service A may become a premium service for a high quality video. Here, the basic service or the premium service may be selected according to a service class.

The controller may configure a target service class for traffics of the service A according to information on a permissible usage amount (quota) for the service A so as to control the network apparatus. Here, the target service class may be information for classifying service classes such as the base service and the premium service, according to permissible usage amounts for respective services.

First, the service management system may request the controller to control the service A by transferring service profile information, and a service control policy (S800).

A case, in which a permissible usage amount of the service A for the premium service is configured to be IGB, will be explained.

When a traffic for the service A occurs in a user terminal, the traffic may be inputted to the network apparatus (S811). Since the network apparatus does not have information on whether to provide the traffic as the basic service or the premium service, the network apparatus may forward the traffic to the controller (S812).

The controller may identify a flow entry for controlling the corresponding traffics, and request the network apparatus to add the flow entry (S821, S822). In this case, the service A may be provided as a premium service until the usage amount of the service A reaches 1 GB, and provided as a basic service after the usage amount of the service A reaches 1 GB.

The controller may request the network apparatus to add a first flow entry, which forwards packets belonging to the service A to the premium service until the 1 GB quota is reached (S821), and the network apparatus may apply a service policy corresponding to the first flow entry.

The controller may request the network apparatus to add a second flow entry, which forwards packets belonging to the service A to the basic service after the 1 GB quota is reached (S822). Through these, the network apparatus may update its flow by using the above two flow entries (S830).

The traffics which are temporarily stored in the network apparatus may be matched to the first flow entry, and may be forwarded to the premium service (S840). Through this, the premium service such as a high-quality video service can be provided. Also, the network apparatus may update the first flow entry by adding information on usage amount of the traffics belong to the service A. That is, since the first flow entry is configured to be deleted when the usage amount of the service A reaches 1 GB, traffics of the service A may be forwarder to the premium service.

If the usage amount of traffics belonging to the service A reached 1 GB (Quota Full) (S850), the network apparatus may delete the first flow entry for the premium service (S861), and notify the controller of that the first flow entry has been deleted (S862).

After then, traffics for the service A may be inputted to the network apparatus (S871), and matched to the second flow entry so that the traffics for the service A may be forwarded to the basic service (S873).

Therefore, the controller may apply the first flow entry for provisioning of the premium service to traffics until the usage amount of the traffics reaches the preconfigured quota, and apply the second flow entry for provisioning of the basic service to traffics after the usage amount of the traffics reaches the preconfigured quota.

The above-described dynamic traffic control methods according to the present invention may reduce communication loads between the network apparatus and the controller and system loads of the network apparatus, and provide real-time service through dynamic control on traffics.

Also, the methods, as traffic path control and QoS control techniques, may be applied to new services such as user interest based advertisements, user network access authentication services, network-based internet supplementary services, etc. of telecommunication operators.

While the example embodiments of the present invention and their advantages have been described in detail, it should be understood that various changes, substitutions and alterations may be made herein without departing from the scope of the invention.

1. A method for controlling traffic in a software defined networking (SDN) environment, performed by a controller, the method comprising:
creating at least one flow entry for controlling a traffic of a network apparatus; and
controlling the traffic of the network apparatus by transferring the created at least one flow entry to the network apparatus,
wherein the at least one flow entry contains information of a threshold value or a target value for the traffic for controlling the traffic.

2. The method according to claim 1, wherein the threshold value or the target value for the traffic includes at least one of target counter information of the traffic, target service class information of the traffic, and quota information of the traffic.

3. The method according to claim 1, wherein the controlling the traffic of the network apparatus comprises:
updating a flow table of the network apparatus by transferring the at least one flow entry to the network apparatus; and
applying, to the network apparatus, a traffic control policy corresponding to the at least one flow entry included in the updated flow table.

4. The method according to claim 1, wherein, in the controlling the traffic of the network apparatus, the traffic of the network apparatus is controlled by transferring, to the network apparatus, the at least one flow entry configured based on target counter information of the traffic.

5. The method according to claim 4, wherein the target counter information of the traffic is compared with counter information of the traffic which is increased by the network apparatus based on a number of transmitted packets belonging to the traffic.

6. The method according to claim 5, wherein, in the controlling the traffic of the network apparatus, a first flow entry is applied when the counter information of the traffic does not exceed than the target counter information of the traffic, and a second flow entry is applied when the counter information of the traffic exceeds the target counter information of the traffic.

7. The method according to claim 6, wherein, in the controlling the traffic of the network apparatus, the first flow entry is deleted from the network apparatus after applying the first flow entry.

8. The method according to claim 5, wherein, in the controlling the traffic of the network apparatus, an advertisement service is provided through the traffic when the counter information of the traffic is a predetermined value.

9. The method according to claim 8, wherein the predetermined value indicates a first traffic of the traffic.

10. The method according to claim 1, wherein the controlling the traffic of the network apparatus comprises:
transferring, to the network apparatus, the at least one flow entry including target service class information of the traffic, the target service class information being configured based quota information of the traffic; and
controlling the traffic from the network apparatus according to the target service class information of the traffic.

11. The method according to claim 10, wherein, in the controlling the traffic of the network apparatus, the traffic is controlled to be forwarded to a premium service when a usage amount of the traffic does not exceed the quota information of the traffic.

12. The method according to claim 10, wherein, in the controlling the traffic of the network apparatus, a first flow entry for provisioning of the premium service is applied when the usage amount of the traffic does not exceed than the quota information, and a second flow entry for provisioning of a basic service is applied when the usage amount of the traffic exceeds the quota information.

13. The method according to claim 12, wherein, in the controlling the traffic of the network apparatus, the first flow entry is deleted from the network apparatus after applying the first flow entry.

14. A method for controlling traffic in a software defined networking (SDN) environment, performed by a network apparatus, the method comprising:
transferring traffic generated in a user terminal to a controller; and
controlling the traffic generated in the user terminal by receiving at least one flow entry generated by the controller in response to the transferring,
wherein the at least one flow entry contains information of a threshold value or a target value for the traffic for controlling the traffic.

15. The method according to claim 14, wherein the threshold value or the target value for the traffic includes at least one of target counter information of the traffic, target service class information of the traffic, and quota information of the traffic.

16. The method according to claim 14, wherein the controlling the traffic generated in the user terminal comprises:
updating a flow table of the network apparatus by receiving the at least one flow entry from the controller; and
applying a traffic control policy corresponding to the at least one flow entry included in the updated flow table to the traffic generated in the user terminal.

17. The method according to claim 14, wherein, in the controlling the traffic generated in the user terminal, the traffic generated in the user terminal is controlled according to the at least one flow entry configured based on target counter information of the traffic.

18. The method according to claim 17, wherein the target counter information of the traffic is compared with counter information of the traffic which is increased by the network apparatus based on a number of transmitted packets belonging to the traffic.

19. The method according to claim 18, wherein, in the controlling the traffic generated in the user terminal, a first flow entry is applied when the counter information of the traffic does not exceed than the target counter information, and a second flow entry is applied when the counter information of the traffic exceeds the target counter information.

20. The method according to claim 16, wherein, in the controlling the traffic generated in the user terminal, the first flow entry is deleted from the network apparatus after applying the first flow entry.

21. The method according to claim 18, wherein, in the controlling the traffic generated in the user terminal, an advertisement service is provided through the traffic when the counter information of the traffic is a predetermined value.

22. The method according to claim 14, wherein the controlling the traffic generated in the user terminal comprises:
receiving the at least one flow entry including target service class information of the traffic from the controller, the target service class information being configured based quota information of the traffic; and
controlling the traffic generated in the user terminal according to the target service class information of the traffic.

23. The method according to claim 22, wherein, in the controlling the traffic generated in the user terminal, a first flow entry for provisioning of a premium service is applied when the usage amount of the traffic does not exceed than quota information of the traffic, and a second flow entry for provisioning of a basic service is applied when the usage amount of the traffic exceeds the quota information of the traffic.

24. The method according to claim 23, wherein, in the controlling the traffic generated in the user terminal, the first flow entry is deleted from the network apparatus after applying the first flow entry.
